(19) United States
(12) Patent Application Publication
(10) Pub. No.: US 2026/0046985 A1
(43) Pub. Date: Feb. 12, 2026

(54) INDUCTION COOKING APPLIANCE

(71) Applicant: Haier US Appliance Solutions, Inc., Wilmington, DE (US)

(72) Inventors: Nathaniel Lehrer, Louisville, KY (US); Ali Jordan Faraji-Tajrishi, Louisville, KY (US)

(21) Appl. No.: 18/797,782

(22) Filed: Aug. 8, 2024

(51) Int. Cl. H05B 6/06; G01K 7/22; G01K 7/36

(52) U.S. Cl. CPC H05B 6/065; G01K 7/22; G01K 7/36; H05B 2213/05; H05B 2213/07

(57) ABSTRACT

An induction cooking appliance comprises at least one non-overlapping induction coil associated with a heating area for heating a cooking vessel and a sense assembly. The sense assembly comprises a thermistor proximal to the heating area and a conductor lead coupled with the thermistor. The sense assembly further comprises a plurality of flux concentrators proximal to the heating area and a plurality of flux sense windings defined by the conductor lead wound around the plurality of flux concentrators, respectively. The plurality of flux sense windings provides electrical parameters correlated to variation of magnetic flux. The induction cooking appliance further includes a controller configured to determine a position of the cooking vessel and a temperature of the heating area based at least in part on the electrical parameters of the plurality of flux sense windings.

### FIELD

Example aspects of the present disclosure relate generally to induction cooking appliances such as induction ovens, and more particularly, to induction control systems for induction cooking appliances.

### BACKGROUND

Induction cooking appliances heat conductive cookware by magnetic induction. An induction cooking appliance applies radio frequency current to an induction heating coil to generate a strong radio frequency magnetic field on the heating coil. When a conductive vessel, such as a load (e.g., a pan), is placed over the heating coil, the magnetic field coupling from the heating coil may generate eddy currents within the vessel, causing the vessel to increase in temperature.

### SUMMARY

Aspects and advantages of embodiments of the present disclosure will be set forth in part in the following description, or can be learned from the description, or can be learned through practice of the embodiments.

One example aspect of the present disclosure is directed to a method for sensing a temperature of an induction cooking appliance having a plurality of induction coils associated with a heating area and a position of a cooking vessel. The method includes determining, by a sense assembly associated with the heating area, sensed electrical parameters indicative of a change in temperature and a variation of magnetic flux associated with a first induction coil corresponding to the heating area. The sensed electrical parameters are determined based at least in part on a thermistor, a thermistor lead, a flux concentrator, and a flux sense winding defined by the thermistor lead wound around the flux concentrator. The method also includes determining the temperature of the heating area and the position of the cooking vessel based at least in part on the variation of magnetic flux correlated to by the sensed electrical parameters sensed by the sense assembly and the temperature of the heating area correlated to the sensed electrical parameters sensed by the thermistor of the sense assembly.

Another example aspect of the present disclosure is directed an induction cooking appliance that includes at least one non-overlapping induction coil associated with a heating area for heating a cooking vessel and a sense assembly. The sensing assembly includes a thermistor proximal to the heating area and a conductor lead coupled with the thermistor. The sensing assembly also includes a plurality of flux concentrators proximal to the heating area and a plurality of flux sense windings defined by the conductor lead wound around the plurality of flux concentrators, respectively. The plurality of flux sense windings provides electrical parameters correlated to variation of magnetic flux. The cooking appliance also includes a controller configured to determine a position of the cooking vessel and a temperature of the heating area based at least in part on the electrical parameters of the plurality of flux sense windings.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 illustrates a perspective view of an induction cooking appliance according to example embodiments of the present subject matter.

FIG. 2 illustrates a perspective view of the induction cooking appliance of FIG. 1 having two induction coils according to example embodiments of the present subject matter;

FIG. 3 illustrates a perspective view of an example induction cooking appliance of having generally radially opposite flux sense windings according to example embodiments of the present subject matter;

FIG. 4 illustrates a perspective view of an example induction coil having two sets of flux concentrators.

FIG. 5 illustrates a perspective view of an induction coil having flux concentrators each with flux sense windings according to example embodiments of the present disclosure;

FIG. 6 depicts an example graphical representation of changes in position compared to a current of the induction coil of FIG. 2 according to example embodiments of the present disclosure;

FIG. 7 depicts an example graphical representation of changes in position compared to a current of the induction coil of FIG. 2 according to example embodiments of the present disclosure;

FIG. 8 depicts four example graphic representations of the current in the coil, combined voltage detected as temperature and position change, isolated voltage as temperature changes, and isolated voltage as position changes according to example embodiments of the present disclosure; and

FIG. 9 provides a flowchart of an example method for providing power to the induction coils according to example embodiments of the present disclosure.

Repeat use of reference characters in the present specification and drawings is intended to represent the same and/or analogous features or elements of the present invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Induction cooking appliances may have induction heating systems configured to heat a load (e.g., a pan, cookware, vessel, etc.). The induction heating system may include one or more coils (e.g., induction coils) operable to inductively heat one or more loads with a magnetic field and an inverter system operable to supply alternating current through the coil. Electrical parameters such as the current passing through the coil are important in deciding a variety of operational characteristics/states of the induction heating system. For example, electric parameters, or specifically, induction coil parameters may be used to determine an output power of the induction coil or if a load is present on a coil of the induction cooking appliance.

Some induction heating systems may include systems and methods to measure induction coil parameters. For instance, some induction heating systems may use various current sensing devices (e.g., current transducers, current sensors, current transformers, Hall effect sensors, etc.) to provide a measurement signal indicative of induction coil parameters such as coil current. However, these sensing devices may be extravagant and may not fit in smaller induction cooking appliances as the components of the system take up space.

Accordingly, the present disclosure includes a hardware solution for determining a temperature of a heating surface and a position of a cooking vessel within an induction cooking system. This solution saves space by utilizing leads to a thermistor to detect flux.

Example aspects of the present disclosure provide many technical effects and benefits. For instance, an induction heating system according to the present disclosure may provide for improved accuracy and precision in determining induction system parameters such as pan position by canceling polarity of voltages of windings with equal and opposite flux. Furthermore, induction coil current may be estimated by adding (as opposed to canceling) of voltages generated in the flux transformers.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (e.g., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” do not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

The terms “coupled,” “fixed,” “attached to,” and the like refer to both direct coupling, fixing, or attaching, as well as indirect coupling, fixing, or attaching through one or more intermediate components or features, unless otherwise specified herein.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

Referring now to the figures, example aspects of the present disclosure will be discussed in greater detail.

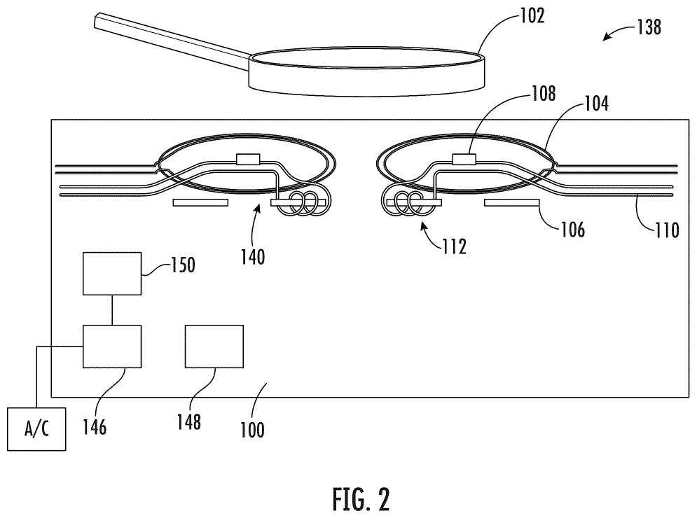

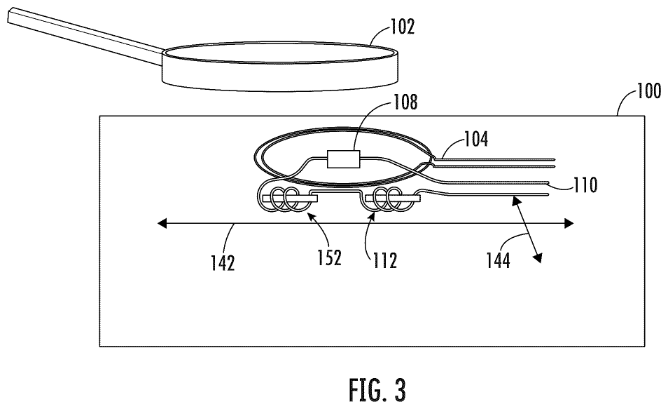

FIG. 3 provides a perspective view of an induction cooking appliance 100 according to example embodiments of the present disclosure. Specifically, FIG. 2 provides a front, perspective view of the induction cooking appliance 100 having two induction coils 104, as may be employed with the present subject matter.

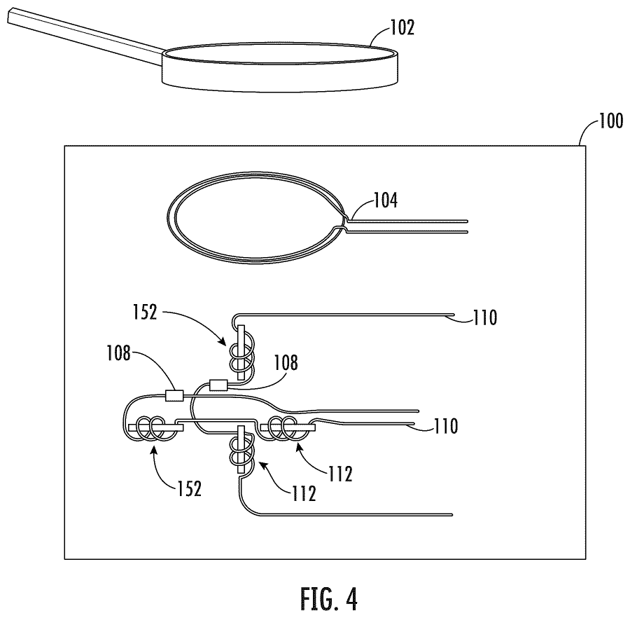

FIG. 4 provides a perspective view of the induction cooking appliance 100. Specifically, FIG. 4 provides a front, perspective view of the induction cooking appliance 100 having one induction coil 104 with two flux sense windings 112 that are generally radially opposite, as may be employed with the present subject matter. The induction cooking appliance 100 having the of induction coil 104 with a series of flux sense windings 112 that are generally radial arranged.

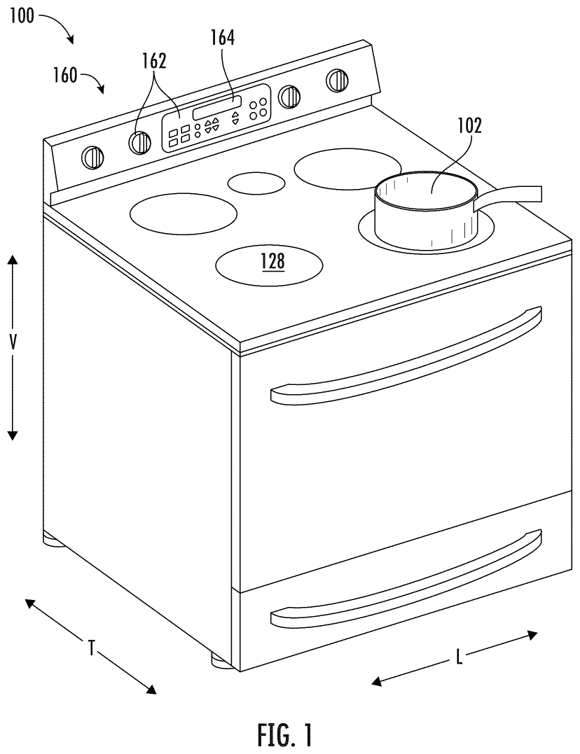

As shown in FIGS. 2 through 4, the induction cooking appliance 100 of the present disclosure may be a range appliance; however, the induction cooking appliance may include an oven as well. However, it should be appreciated that the induction cooking appliance 100 is provided by way of example only, and aspects of the present subject matter may be used in any suitable induction cooking appliance, such as an oven, a cooktop, or a range appliance. Thus, the example embodiment shown in FIGS. 1 through 4 are not intended to limit the present subject matter to any particular cooking configuration or arrangement. Indeed, aspects of the present subject matter may be applied to induction heating elements of any suitable appliance.

The induction cooking appliance 100 generally defines a vertical direction V, a lateral direction L, and a transverse direction T, each of which is mutually perpendicular, such that an orthogonal coordinate system is generally defined. As illustrated, the induction cooking appliance 100 includes a heating area 138 that extends in the lateral direction L and the transverse direction T. The heating area 138 is positioned at or adjacent a top of the induction cooking appliance. As shown in FIG. 1, the heating area 138 may be constructed of glass, ceramics, enameled steel, and combinations thereof. The heating area 138 is for supporting cooking vessels, such as pots or pans for example, during a cooking process.

The induction cooking appliance 100 generally includes a power supply 146. The power supply 146 may receive AC power from an AC supply, for example, which may provide conventional 60 Hz 120 or 240 volt AC supplied by utility companies. The power supply 146 may include rectification circuitry for rectifying the power signal from the AC supply. In addition, the power supply 146 may include filtering and power factor correction circuitry to filter the rectified power signal. In some embodiments, the AC supply and/or the power supply 146 is configured to provide AC power to multiple induction coils 104.

The induction cooking appliance 100 further includes at least one induction coil 104 operable to inductively heat a load. As shown in FIG. 2, the induction cooking appliance 100 includes an inverter 150 and is operatively coupled to power supply 146.

The induction cooking appliance 100 includes the induction coil 104 and the inverter 150, such as a resonant inverter system. The induction coil 104, when supplied with an alternating current by the inverter 150, inductively heats the cooking vessel 102 (e.g., pan, pot) or other object placed on, over, or near the induction coil 104. It will be understood that use of the term “load” herein is used merely as an example, and that term will generally include any object of a suitable type that is capable of being heated by an induction coil 104.

The induction cooking appliance 100 may include a control panel assembly 160 within convenient reach of a user of the induction cooking appliance 100. For example, the user may interact with the control panel assembly 160 and determine the amount of heat input provided by the induction cooking appliance 100 for cooking food items on the heating area 138. Specifically, control panel assembly 160 may include various input components, such as one or more of a variety of touch-type controls, electrical, mechanical or electro-mechanical input devices including rotary dials, push buttons, and touch pads. Control panel assembly 160 may also be provided with one or more graphical display devices or display components, such as a digital or analog display device designed to provide operational feedback or other information to the user such as e.g., whether a particular induction coil 104 is activated and/or the rate at which the induction coil 104 is set. Indeed, according to the illustrated embodiment, control panel assembly 160 includes a display assembly 164, such as a liquid crystal display with an interactive display and interface.

Generally, the induction cooking appliance 100 may include a controller 160 in operative communication with the control panel assembly 160. The control panel assembly 160 of the induction cooking appliance 100 may be in communication with the controller 148 via, for example, one or more signal lines or shared communication busses, and signals generated in the controller 148 operate the induction cooking appliance 100 in response to user input via user input devices, e.g., control knobs 162 and/or display assembly 164. Input/Output (“I/O”) signals may be routed between the controller 148 and various operational components of the induction cooking appliance 100 such that operation of the induction cooking appliance 100 can be regulated by the controller 148. In addition, the controller 148 may also be in communication with one or more sensors, such as a thermistor 108, which may be used to measure temperature inside near the heating area 138 and provide such measurements to the controller 148. Although the thermistor is illustrated near the heating area 138, it should be appreciated that other sensor types, positions, and configurations may be used according to alternative embodiments.

The controller 148 may be configured to control the power of the induction coil 104 by controlling the switching frequency of inverter 150. For example, the controller 148 may include a microcontroller and/or gate driver to drive individual transistors or switching devices of the induction coil 104 (e.g., inverter system 150 of induction cooking appliance 100) with pulse-width modulated signals. The controller 148 may include a memory and one or more microprocessors, microcontrollers, application-specific integrated circuits (ASICS), CPUs or the like, such as general or special purpose microprocessors operable to execute programming instructions or micro-control code associated with operation of the induction cooking appliance 100, and the controller 148 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, the controller 148 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Although aspects of the present subject matter are described herein in the context of a single oven appliance, it should be appreciated that the induction cooking appliance 100 is provided by way of example only. Other oven or range appliances having different configurations, different appearances, and/or different features may also be utilized with the present subject matter, e.g., double ovens, connected oven/cooktop units, etc. Moreover, aspects of the present subject matter are equally applicable to standalone cooktops (e.g., without cooking chambers) or other cooking appliances.

Referring now specifically to FIGS. 1 through 4, the induction coils 104 of the induction cooking appliance 100 are non-overlapping and associated with the heating area 138. The heating area 138 may generally be referred to as a stove top. The induction cooking appliance 100 includes a sense assembly 140, or sense circuit, positioned proximal the heating surface 138 so as to sense the cooking vessel 102 and temperature of the heating area 138. The sense assembly 140 includes a thermistor 108. The thermistor 108 is communicatively coupled with the controller 148. As temperatures change in the thermistor 108, the resistance of the thermistor 108 also changes. The resulting resistance change is signaled to the controller 148. The thermistor 108 may conceivably be a negative temperature coefficient thermistor or a positive coefficient temperature coefficient thermistor. In each case, the resistance either decreases as temperature increases or increases as temperature increases, respectively. The controller 148 determines the temperature of the thermistor 108 by interpreting a change in voltage.

The sense assembly 140 also includes a conductor lead 110 that is coupled with the thermistor 108. The sense assembly 140 further includes a plurality of flux concentrators 106, which may be referred to as ferrite bars. The ferrite bars 106 are used to measure flux under the induction coil 104. Flux can be measured by adding a conductive wire wrapped around one or more ferrite bars 106, and by measuring the voltage induced on the wire, that is proportional to the flux according to Faraday's law:

$$ε = - N * \frac{d {Φ}_{B}}{dt}$$

where ε is the electromotive force (in Volts), N is the number of turns of wire and @B is the magnetic flux (in Weber) through a single loop. Since the magnetic flux is generated by the alternate current flowing in the coil, the magnetic field B module and phase are related to the coil current, and, as a consequence, the voltage induced on the wire is equal to the derivative of the periodic signal and related to the voltage at coil terminals.

In the present disclosure, the conductor lead 110 is wound around the flux concentrator 106. Thus, the ferrite bar and the wound conductor lead 110 form a flux sense winding 112, which may also be referred to as a flux transformer. The flux generated by the induction coil 108 and the flux sense winding 112 further depend on the cooking vessel 102. Specifically, the flux changes based on a location of the cooking vessel 102. The conductor leads 110 are coupled to the induction coil 104 in such a way that flux is determined by a flux signal imparted on the conductor leads 110. For example, the flux at the induction coil 108 will increase as the cooking vessel 102 is positioned closer to the flux sense winding 112.

According to FIGS. 2 and 4, the conductor lead 110 may be wound in one direction, for example clockwise, around the flux concentrator 106. Additionally, or alternatively, the conductor lead 110 may be wound in one direction around a plurality of flux concentrators 106 associated with the induction coil 104. In the examples illustrated in FIGS. 1 and 3, the electric parameters, or specifically, induction coil parameters may be used to determine an output power of the induction coil or if a load is present on a coil of the induction cooking appliance. One induction coil parameter, the flux, can determine a first distance of the cooking vessel 102 from a first center of a first induction coil 104 of the plurality of induction coils. For example, the first distance may be along the lateral direction L or the transverse direction T. Additionally, or alternatively, the flux may determine the first distance of a cooking vessel center of the cooking vessel 102 from a first center of a first induction coil 104 of the plurality of induction coils. One example of determining the first distance is by using a ratio. Generally, the ratio is equal to a sub flux divided by a total flux. The total flux is equal to a proportional flux of a current in the induction coil 104 added to the sub flux. Flux sensed in the first flux sense winding 112 may also be referred to as the sub flux or a transformer flux. Therefore, a first ratio is equal to a first flux sensed by a first flux sense winding 112 divided by the first flux sensed by the flux sense winding added to a first proportional flux of a first current of the first induction coil 104.

Using the immediately abovementioned ratio can be repeated with subsequent induction coils 104 and subsequent flux sense windings 112 to locate the cooking vessel 102 because a subsequent distance of the cooking vessel 102 from the subsequent induction coil 104 will overlap with the first distance of the cooking vessel 102 from the first induction coil 104. The subsequent distance would be, for example, along the lateral direction L or the transverse direction T. Additionally, or alternatively, the first distance would be along one of the lateral direction L and the transverse direction T, and the subsequent would be along the opposite direction of the first direction. Using the ratio can even be repeated with as few as one subsequent, or second, flux sense winding 112 and subsequent, or second, induction coil 104 if the overlap between the first distance and the subsequent, or second, distance only yields one location atop the heating area 138. Additionally, or alternatively, a single induction coil 104 nay be associated with at least two thermistors 108, and the thermistor leads 110 of the second thermistor could be wound around perpendicular flux concentrators 106 to calculate the first ratio and the subsequent ratio to determine the position of the cooking vessel 102.

The voltage measured by the flux sense winding 112 may be indicative of the current through induction coil 104. This is due to the relationship between current (I), capacitance (C), and the rate of change in the voltage across the capacitor with respect to time

$$( \frac{dv}{dt} ) ,$$

which is reflected by the following formula:

$$I = C * \frac{dv}{dt}$$

This formula and Faraday's law, stated above, allows for the summation of the current in the induction coil 104 and the sub flux to calculate the total flux. Furthermore, the above stated approach is made possible by splitting the current into an alternating current (AC) component and a direct current (DC) component, where the AC component is used to measure the current and the sub flux. One example of how to split the AC component and the DC component is by using a circuit filter, or more specifically, a low-pass filter, or even more specifically, an RC low-pass filter. In a low-pass filter, frequencies below a certain point pass with little attenuation, while frequencies above the same point are attenuated. The DC component passes. By subtracting the DC component from the original signal, the AC component is known. The DC component of the output signal that is calculated allows the temperature and thermistor parameters to be inferred. One factor, for example an impedance of the DC component, will impact the AC amplitude output by a measurement circuit, for example. Thus, the example AC amplitude is compensated for by the controller 148 when sampling the AC signal.

With reference to FIG. 3, the plurality of flux concentrators 106 are arranged in a radial pattern. The first flux sense winding 112 of the plurality of flux sense windings is wound clockwise. An opposite flux sense winding 152 is generally radially opposed to the first flux sense winding is wound counterclockwise such that a first polarity of a first voltage associated with the flux sense winding 112 is canceled out by an opposite polarity of an opposite voltage of the opposite flux sense winding 152. Because the respective polarities are canceled out, another electrical parameter, a differential flux measurement can be used to sense a directional distance from which the cooking vessel 102 is offset from the induction coil 104. For example, if the cooking vessel 102 is offset from the induction coil 104 to the left, the flux sense winding 112 may detect a +90 degree voltage signal phase and a −90 degree voltage signal phase if the cooking vessel 102 is offset to the right of the induction coil 104 because phase shift is relative to the induction coil current. The amplitude of the signal would be proportional to the amount of positional offset.

The example illustrated in FIG. 3 allows for the flux sense winding 112 to detect a direction distance the cooking vessel 102 is offset from the induction coil 104. The direction of the directional distance is aligned with the first flux sense winding 112 and the opposite flux sense winding 152. Therefore, the position of the cooking vessel 102 can be determined by sensing two directional distances between the cooking vessel 102 and at least one induction coil 104, so long as the directional distances are not parallel. The first directional distance and the second directional distance may be determined by two sets of two flux concentrators that are perpendicular and associated with the first induction coil 104, as illustrated in FIG. 4. The subsequent flux sense winding 152 may be associated with the first induction coil 104.

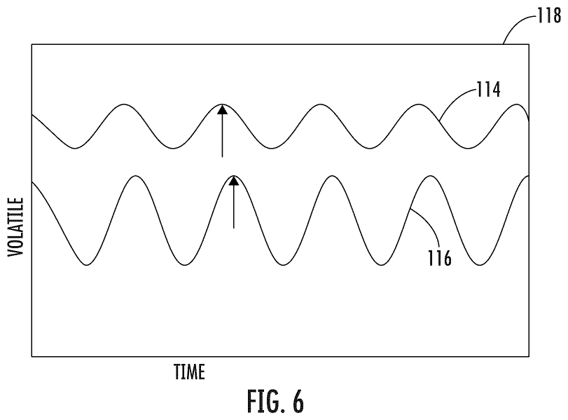

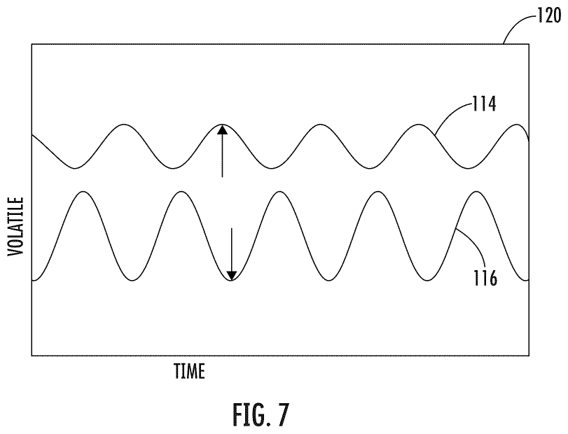

With reference to FIG. 6 and FIG. 7, the first graph 118 demonstrates one example of how a winding voltage 116 compares to the current 114 of the induction coil 104 when the cooking vessel 102 is offset from the induction coil 104 in a first direction. In contrast, the second graph 120 demonstrates an example of how the phase and the amplitude of the winding voltage 116 may change as the cooking vessel 102 is offset in a second direction from the induction coil 104, where the first direction and the second direction are aligned on a common axis with the first flux sense winding 112 and the opposite flux sense winding 152. For example, the controller 148 may determine the directional distance from which the cooking vessel 102 is offset from the induction coil 104 by comparing the amplitude and phase of the winding voltage 116 compared to the current 114 of the induction coil 104.

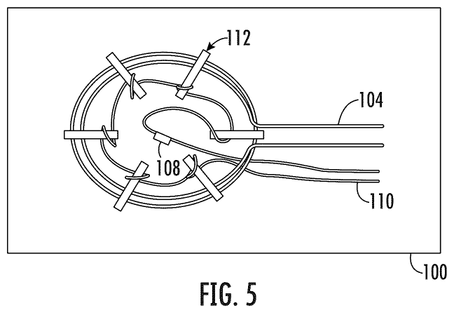

With regard to FIGS. 1 through 5, the controller 148 directs power to the heating area 138 to where the cooking vessel 102 is located. The controller 148 may direct power to one induction coil 148, the plurality of induction coils 104, or the controller 148 may direct power to part of one induction coil 104 and part of a second induction coil 104 based on the location of the cooking vessel 102.

Furthermore, the controller 148 may direct power to the plurality of induction coils 104 based on a detected temperature of the heating area 138 via the thermistor 108.

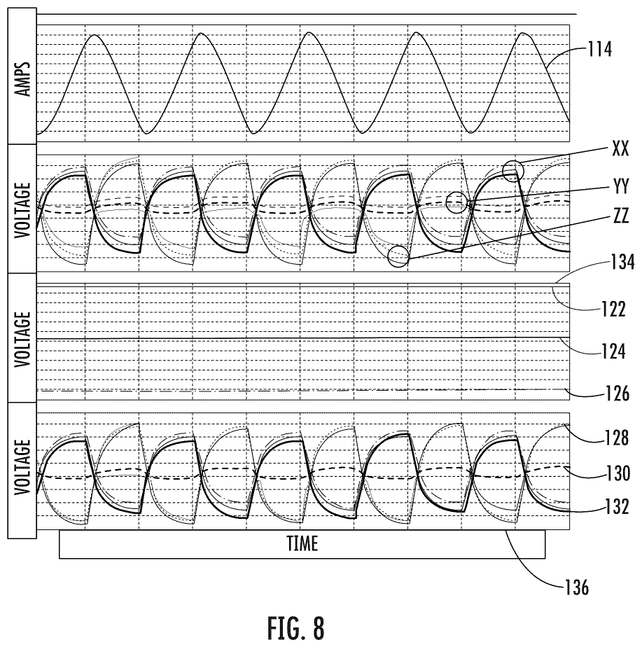

With reference to FIG. 8, there are three sets of three different traces; namely a first trace set XX, a second trace set YY, and a third trace set ZZ. The first trace set XX, the second trace set YY, and the third trace set ZZ contain three traces which correspond to a similar position of the cooking vessel 102. Within the first trace set XX, the second trace set YY, and the third trace set ZZ there is a direct current offset between each of the three traces which is caused by temperature difference.

With further reference to FIG. 8, the topmost graph demonstrates an example of the current 114 of the induction coil 104 measured over time. The second from the top graph demonstrates an example of a combined voltage measured in the thermistor leads 110 over three different temperatures and three different positions of the cooking vessel 102. The third from the top (and second from the bottom) graph demonstrates three example voltages measured by the thermistor leads 110 that are indicative of the three different example temperatures. The three example voltages indicative of the three example temperatures are measured after the voltage has passed through the low-pass filter, for example. Therefore, the voltages demonstrated in the third from the top (and second from the bottom) graph are from the DC component 134. The bottommost graph demonstrates three example voltages of the thermistor leads 110 that are indicative of three different directional distances the cooking vessel 104 may be offset from the induction coil 104.

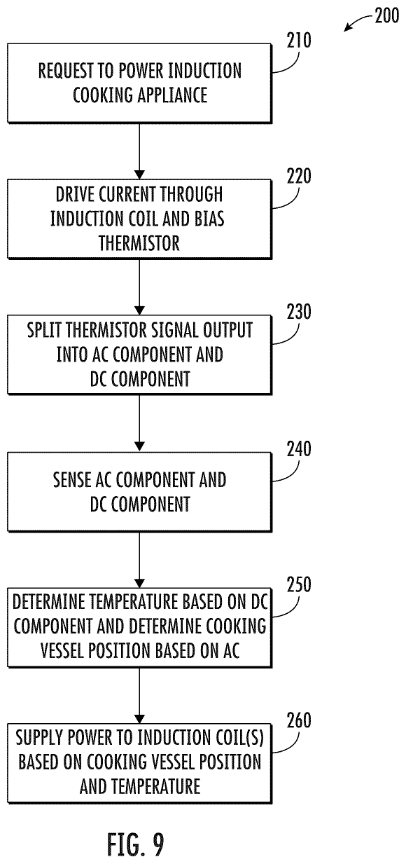

With reference to FIGS. 1 through 9, for example, a circuitry of the induction cooking appliance 100 may separate the AC component 136 and the DC component 134 of the current of the circuitry, the controller 148 may then determine temperature of the heating area 138 and position of the cooking vessel 102. FIG. 7 illustrates an example method 200 of how the induction cooking appliance 100 may heat the cooking vessel 102. Step 210 may be a request to power the induction cooking appliance 100. The request may come from a user via the knob 162. The current would then flow through the induction coil 104 and bias the thermistor leads 110, in example step 220. As stated in step 230, the circuitry of the induction cooking appliance 100 may then split the current into the AC and DC components 136, 134. In step 240, the flux sense winding 112 senses the AC component 136 and the DC component 134. The controller 148 then determines the temperature of the heating area 138 and the position of the cooking vessel 102 based on the AC and DC components 136, 134, as stated in step 250. In example step 260, the controller 148 directs power from the power supply 146 and/or the inverter 150 to the induction coil 104 based on the determinates of the temperature and the position of the cooking vessel 102.

Although specific features of various embodiments may be shown in some drawings and not in others, this is for convenience only. In accordance with the principles of the present disclosure, any feature of a drawing can be referenced and/or claimed in combination with any feature of any other drawing.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method for sensing a temperature of an induction cooking appliance having a plurality of induction coils associated with a heating area and a position of a cooking vessel, the method comprising:
determining, by a sense assembly associated with the heating area, sensed electrical parameters indicative of a change in temperature and a variation of magnetic flux associated with a first induction coil corresponding to the heating area, wherein the sensed electrical parameters are determined based at least in part on a thermistor, a thermistor lead, a flux concentrator, and a flux sense winding defined by the thermistor lead wound around the flux concentrator; and
determining the temperature of the heating area and the position of the cooking vessel based at least in part on:
the variation of magnetic flux correlated to by the sensed electrical parameters sensed by the sense assembly; and
the temperature of the heating area correlated to the sensed electrical parameters sensed by the thermistor of the sense assembly.

2. The method according to claim 1, further including the steps of:
separating a current of the sense assembly into a direct current component and an alternating current component;
factoring in the sensed electrical parameters; and
deriving a position of the cooking vessel from an amplitude of the alternating current component.

3. The method according to any of the claim 2, wherein the electrical parameters comprise at least one of the following values:
an output induced mean voltage corresponding to the direct current component;
a peak-to-peak voltage corresponding to the alternating current component;
a voltage signal phase corresponding to the alternating current component;
a root mean square voltage; or
a root mean square voltage on a time interval around its peak value.

4. The method according to claim 3, wherein the direct current component determines the temperature of the heating area, and wherein the alternating current component determines the variation of magnetic flux.

5. The method according to claim 1, further comprising the step of canceling a polarity of a voltage of the flux concentrator by:
positioning the cooking vessel generally axially aligned with the induction coil;
having the thermistor lead wound clockwise around the flux concentrator; and
having the thermistor lead wound counterclockwise around a generally radially opposite flux concentrator.

6. The method according to claim 5, further comprising the step of determining a first directional distance of the cooking vessel from a first induction coil of the plurality of induction coils along a first axis aligned with the flux concentrator and the generally radially opposite flux concentrator by measuring the voltage signal phase at the thermistor leads.

7. The method according to claim 6, further comprising the step of detecting a position of the cooking vessel by:
determining a second directional distance of the cooking vessel along a second axis aligned with a third flux concentrator and a fourth flux concentrator that is generally radially opposite the third flux concentrator by measuring the voltage signal phase at a second induction coil of the heating area; and
combining the first directional distance and the second directional distance atop the induction cooking appliance.

8. The method of claim 1, further comprising the step of determining a position of the cooking vessel via the following sub steps:
measuring a first current of a first induction coil of the plurality of induction coils;
reading a sub flux of a first flux concentrator via the flux sense winding;
totaling the first current and the first sub flux;
calculating a first ratio of the sub flux to a total flux;
measuring at least one subsequent current of at least one subsequent induction coil of the plurality of induction coils;
reading at least one subsequent sub flux of at least one subsequent flux concentrator via at least one subsequent flux sense winding;
totaling the subsequent current and the subsequent sub flux;
calculating a subsequent ratio of the subsequent sub flux to a subsequent total flux; and
comparing the first ratio to the subsequent ratio.

9. The method according to claim 8, wherein the first ratio corresponds to the cooking vessel being a first distance from the first induction coil, wherein the subsequent ratio corresponds to the cooking vessel being a second distance from the subsequent induction coil, and wherein the step of determining the position of the cooking vessel further comprises determining where the first distance intersects the subsequent distance.

10. An induction cooking appliance comprising:
at least one non-overlapping induction coil associated with a heating area for heating a cooking vessel;
a sense assembly comprising:
a thermistor proximal to the heating area;
a conductor lead coupled with the thermistor;
a plurality of flux concentrators proximal to the heating area; and
a plurality of flux sense windings defined by the conductor lead wound around the plurality of flux concentrators, respectively, and wherein the plurality of flux sense windings provides electrical parameters correlated to variation of magnetic flux; and
a controller configured to determine a position of the cooking vessel and a temperature of the heating area based at least in part on the electrical parameters of the plurality of flux sense windings.

11. The induction cooking appliance according to claim 10, wherein a first flux sense winding of the plurality of flux sense windings is configured to measure a first sub flux, wherein a first total flux is equal the first sub flux and a first proportional flux of a first current in a first induction coil, and wherein a first ratio is proportional to the first sub flux and the first total flux.

12. The induction cooking appliance according to claim 11, wherein a vessel position of the cooking vessel is determined by the controller by comparing the first ratio of the first flux sense winding of the plurality of flux sense windings with at least a second flux ratio of a second flux sense winding of the plurality of flux sense windings to locate the vessel position in order for the controller to balance heat provided to the surface of the cooking vessel.

13. The induction cooking appliance according to claim 11, wherein the plurality of flux concentrators are arranged in a radial pattern, wherein the first flux sense winding of the plurality of flux sense windings is wound clockwise, and wherein an opposite flux sense winding that is generally radially opposed to the first flux sense winding is wound counterclockwise such that a first polarity of a first voltage associated with the flux sense winding is canceled out by an opposite polarity of an opposite voltage of the opposite flux sense winding.

14. The induction cooking appliance according to claim 13, wherein a vessel position of the cooking vessel is determined by the controller by comparing a first sub flux of the first flux sense winding of the plurality of flux sense windings, and at least a second sub flux of a second flux sense winding of the plurality of flux sense windings, to locate the cooking vessel.

15. The induction cooking appliance of claim 14, wherein first flux sense winding and the second flux sense winding share one of the at least one non-overlapping induction coils.

16. The induction cooking appliance of claim 14, wherein the controller is configured to direct power to at least one of the induction coils in response to locating the vessel position and determining the temperature of the heating area.

17. The induction cooking appliance according to claim 10, wherein the electrical parameters comprise a current, and wherein the controller determines an alternating current component of the current and a direct current component of the current.

18. The induction cooking appliance according to claim 17, wherein the alternating current component is associated with variation in flux, and wherein the direct current component is associated with a resistance change detected by the thermistor.

19. The induction cooking appliance according to claim 17, further comprising:
a circuit filter configured to determine the alternating current component and the direct current component from the current.

20. The induction cooking appliance according to claim 19, wherein the circuit filter comprises a low-pass filter.
